(19) United States
(12) Patent Application Publication
(10) Pub. No.: US 2024/0248737 A1
(43) Pub. Date: Jul. 25, 2024

(54) SELECTIVE CONFIGURATION IN A SOFTWARE-DEFINED DATA CENTER FOR APPLIANCE DESIRED STATE

(71) Applicant: VMWARE, INC, Palo Alto, CA (US)

(72) Inventors: Ivaylo RADOSLAVOV RADEV, Sofia (BG); Mukund GUNTI, Sunnyvale, CA (US); Mayur BHOSLE, San Jose, CA (US); Praveen TIRUMANYAM, Bangalore (IN); Kalyan DEVARAKONDA, Bangalore (IN)

(21) Appl. No.: 18/130,443

(22) Filed: Apr. 4, 2023

(30) Foreign Application Priority Data
Jan. 20, 2023 (IN) 202341004116

(51) Int. Cl. G06F 9/455; G06F 9/445

(52) U.S. Cl. CPC G06F 9/45558; G06F 9/4451; G06F 2009/4557; G06F 2009/45595

(57) ABSTRACT

An example method of managing a configuration of a virtualization management server in a software-defined data center (SDDC), the virtualization management server managing a cluster of hosts and a virtualization layer executing therein, includes: generating, by a service executing in the SDDC, a profile that includes a managed configuration exclusive of an unmanaged configuration, a union of the managed configuration and the unmanaged configuration being a configuration of the virtualization management server; validating, by the service, that the unmanaged configuration in the profile does not include dependencies with the unmanaged configuration; applying, by the service, the profile to the virtualization management server.

### RELATED APPLICATIONS

Benefit is claimed under 35 U.S.C. 119(a)-(d) to Foreign Application Serial No. 202341004116 filed in India entitled “SELECTIVE CONFIGURATION IN A SOFTWARE-DEFINED DATA CENTER FOR APPLIANCE DESIRED STATE”, on Jan. 20, 2023, by VMware, Inc., which is herein incorporated in its entirety by reference for all purposes.

### BACKGROUND

In a software-defined data center (SDDC), virtual infrastructure, which includes virtual machines (VMs) and virtualized storage and networking resources, is provisioned from hardware infrastructure that includes a plurality of host computers (hereinafter also referred to simply as “hosts”), storage devices, and networking devices. The provisioning of the virtual infrastructure is carried out by SDDC management software that is deployed on management appliances, such as a VMware vCenter Server® appliance and a VMware NSX® appliance, from VMware, Inc. The SDDC management software communicates with virtualization software (e.g., a hypervisor) installed in the hosts to manage the virtual infrastructure.

It has become common for multiple SDDCs to be deployed across multiple clusters of hosts. Each cluster is a group of hosts that are managed together by the management software to provide cluster-level functions, such as load balancing across the cluster through VM migration between the hosts, distributed power management, dynamic VM placement according to affinity and anti-affinity rules, and high availability (HA). The management software also manages a shared storage device to provision storage resources for the cluster from the shared storage device, and a software-defined network through which the VMs communicate with each other. For some customers, their SDDCs are deployed across different geographical regions, and may even be deployed in a hybrid manner, e.g., on-premise, in a public cloud, and/or as a service. “SDDCs deployed on-premise” means that the SDDCs are provisioned in a private data center that is controlled by a particular organization. “SDDCs deployed in a public cloud” means that SDDCs of a particular organization are provisioned in a public data center along with SDDCs of other organizations. “SDDCs deployed as a service” means that the SDDCs are provided to the organization as a service on a subscription basis. As a result, the organization does not have to carry out management operations on the SDDC, such as configuration, upgrading, and patching, and the availability of the SDDCs is provided according to the service level agreement of the subscription.

As described in U.S. patent application Ser. No. 17/665,602, filed on Feb. 7, 2022, the entire contents of which are incorporated by reference herein, the desired state of the SDDC, which includes configuration of services running in management appliances of the SDDC, may be defined in a declarative document, and the SDDC is deployed or upgraded according to the desired state defined in the declarative document. In addition, if drift from the desired state is detected, the SDDC is remediated according to the desired state defined in the declarative document. The desired state can include that of a virtualization management server configured to manage a cluster of hosts, the virtualization layers thereon, and the VMs executing therein. The complete configuration of a virtualization management server can be large and complex, including many managed objects and properties thereof. It is desirable to allow for selective configuration of a virtualization management server. For example, there could be several administrators and each of them can manage different parts of the configuration of the virtualization management server. Objects, properties, etc. of a virtualization management server configuration, however, can have various inter-dependencies, which makes selective configuration non-trivial. For example, selectively managing the configuration without accounting for dependencies can result in incorrect configuration and failure to achieve the desired state.

### SUMMARY

One or more embodiments provide a method of managing a configuration of a virtualization management server in a software-defined data center (SDDC), the virtualization management server managing a cluster of hosts and a virtualization layer executing therein. The method includes: generating, by a service executing in the SDDC, a profile that includes a managed configuration exclusive of an unmanaged configuration, a union of the managed configuration and the unmanaged configuration being a configuration of the virtualization management server; validating, by the service, that the unmanaged configuration in the profile does not include dependencies with the unmanaged configuration; and applying, by the service, the profile to the virtualization management server.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a conceptual block diagram of customer environments of different organizations that are managed through a multi-tenant cloud platform.

FIG. 2 illustrates components of a management appliance of an SDDC that are involved in automatically detecting and reporting drift in configuration of services running in the management appliance.

FIG. 3 is a block diagram of a virtualized computing system in which embodiments described herein may be implemented.

FIG. 4 is a block diagram depicting profiles managed by a VI profile service according to embodiments.

FIG. 5 is a flow diagram depicting a method of generating and applying a profile to a virtualization management service in an SDDC according to embodiments.

### DETAILED DESCRIPTION

In one or more embodiments, a cloud platform delivers various services (referred to herein as “cloud services”) to the SDDCs through agents of the cloud services that are running in an appliance (referred to herein as a “agent platform appliance”). The cloud platform is a computing platform that hosts containers or virtual machines corresponding to the cloud services that are delivered from the cloud platform. The agent platform appliance is deployed in the same customer environment as the management appliances of the SDDCs.

In the embodiments described herein, the cloud platform is provisioned in a public cloud and the agent platform appliance is provisioned as a virtual machine, and the two are connected over a public network, such as the Internet. In addition, the agent platform appliance and the management appliances are connected to each other over a private physical network, e.g., a local area network. Examples of cloud services that are delivered include an SDDC configuration service, an SDDC upgrade service, an SDDC monitoring service, an SDDC inventory service, and a message broker service. Each of these cloud services has a corresponding agent deployed on the agent platform appliance. All communication between the cloud services and the management software of the SDDCs is carried out through the respective agents of the cloud services.

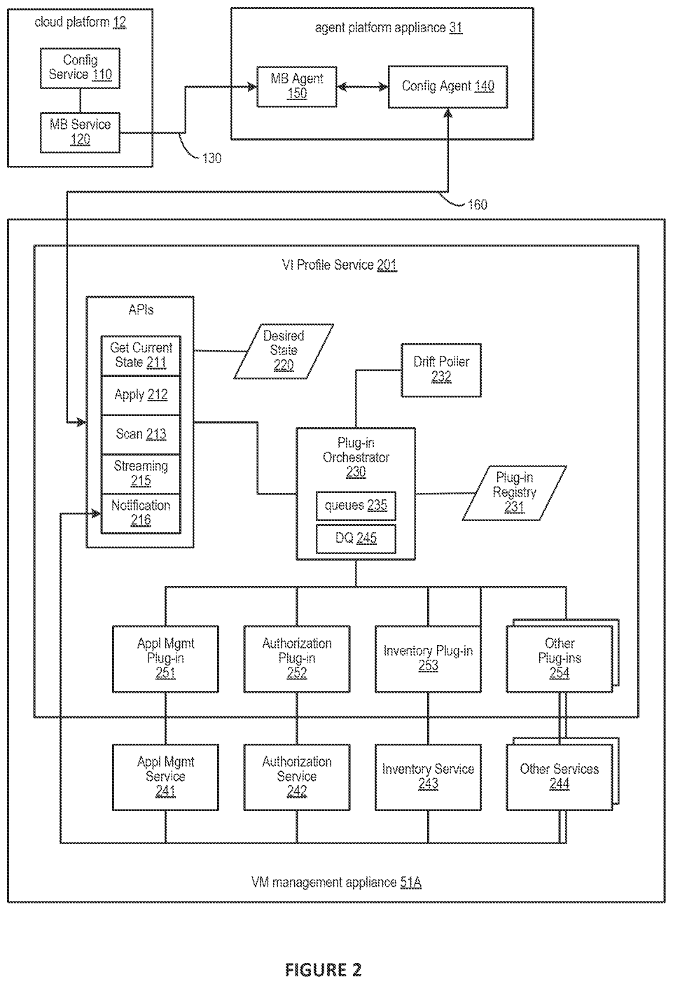

As described in U.S. patent application Ser. No. 17/665,602, the desired state of SDDCs of a particular organization is managed by the SDDC configuration service running in the cloud platform (e.g., configuration service 110 depicted in FIG. 2). The creation of the desired state may be sourced in accordance with techniques described in U.S. patent application Ser. No. 17/711,937, filed Apr. 1, 2022, the entire contents of which are incorporated by reference herein. Once the desired state is created, it serves as a reference point when monitoring for drift, and this in-turn enables troubleshooting and remediation actions to be carried out to eliminate the drift. Eliminating drift may be needed to enforce organization policies, comply with service level agreements, and enable delivery of certain other cloud services, such as upgrade, which require all of the SDDCs managed by an organization to be at the same desired state.

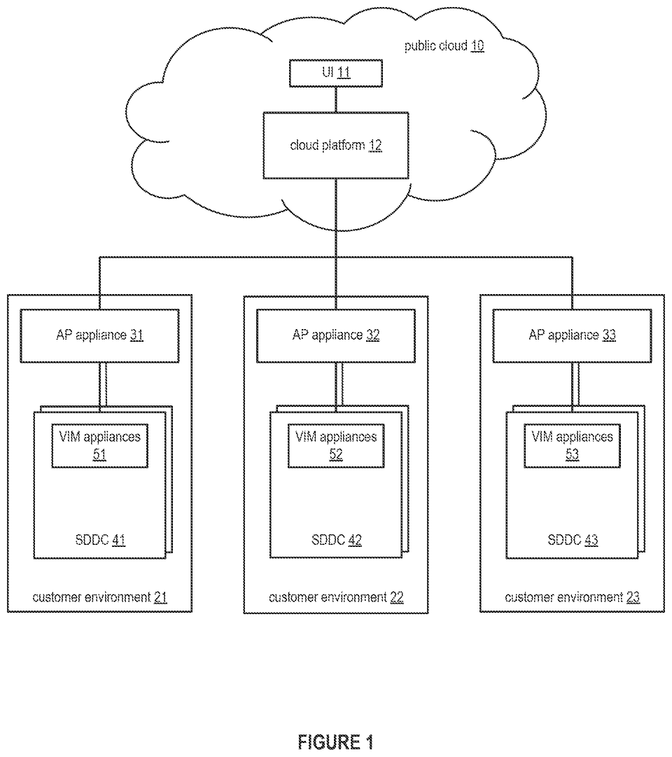

FIG. 1 is a conceptual block diagram of customer environments of different organizations (hereinafter also referred to as “customers” or “tenants”) that are managed through a multi-tenant cloud platform 12, which is implemented in a public cloud 10. A user interface (UI) or an application programming interface (API) that interacts with cloud platform 12 is depicted in FIG. 1 as UI 11.

A plurality of SDDCs is depicted in FIG. 1 in each of customer environment 21, customer environment 22, and customer environment 23. In each customer environment, the SDDCs are managed by respective virtual infrastructure management (VIM) appliances, e.g., VMware vCenter® server appliance and VMware NSX® server appliance. For example, SDDC 41 of the first customer is managed by VIM appliances 51, SDDC 42 of the second customer by VIM appliances 52, and SDDC 43 of the third customer by VIM appliances 53.

The VIM appliances in each customer environment communicate with an agent platform (AP) appliance, which hosts agents (not shown in FIG. 1) that communicate with cloud platform 12, e.g., via a public network such as the Internet, to deliver cloud services to the corresponding customer environment. For example, the VIM appliances for managing the SDDCs in customer environment 21 communicate with AP appliance 31. Similarly, the VIM appliances for managing the SDDCs in customer environment 22 communicate with AP appliance 32, and the VIM appliances for managing the SDDCs in customer environment 23 communicate with AP appliance 33.

As used herein, a “customer environment” means one or more private data centers managed by the customer, which is commonly referred to as “on-prem,” a private cloud managed by the customer, a public cloud managed for the customer by another organization, or any combination of these. In addition, the SDDCs of any one customer may be deployed in a hybrid manner, e.g., on-premise, in a public cloud, or as a service, and across different geographical regions.

In the embodiments described herein, each of the agent platform appliances and the management appliances is a VM instantiated on one or more physical host computers (not shown in FIG. 1) having a conventional hardware platform that includes one or more CPUs, system memory (e.g., static and/or dynamic random access memory), one or more network interface controllers, and a storage interface such as a host bus adapter for connection to a storage area network and/or a local storage device, such as a hard disk drive or a solid state drive. Within a particular customer environment, the one or more physical host computers on which the agent platform appliance and the management appliances are deployed as VMs belong to the same cluster, which is commonly referred to as a management cluster. In some embodiments, any of the agent platform appliances and the management appliances may be implemented as a physical host computer having the conventional hardware platform described above.

FIG. 2 illustrates components of a management appliance 51A of SDDC 41 according to embodiments. In the embodiments described herein, the services running in management appliance 51A include an appliance management service 241 that provides system-level services such as SSH (secure shell), resource utilization monitoring, changing various configurations including network configurations, host name NTP (network time protocol) server name, keyboard layout, and applying patches and updates, an authorization service 242 that is invoked to perform role-based access control to inventory items of SDDC 41, an inventory service 243 that is invoked to create and delete inventory items of SDDC 41, and various other services 244. Each of these services has corresponding plug-ins, namely an appliance management service plug-in 251, an authorization service plug-in 252, an inventory service plug-in 253, and various other plug-ins 254. The plug-ins are registered with virtual infrastructure (VI) profile service 201 when VI profile service 201 is launched.

Virtual infrastructure (VI) profile service 201 is the component in management appliance 51A that manages the configuration of services running in management appliance 51A according to a desired state. For example, VI profile service 201 is a system service of management appliance 51A. In another embodiment (not shown), VI profile service 201 can be a separate appliance (e.g., software running in a separate VM) or execute in a separate container from management appliance 51A. These services are referred to hereinafter as “managed services” and the desired state of these services are defined in a desired state document (depicted in FIG. 2 as desired state 220) that contains the desired state of the entire SDDC 41. In the embodiments described herein, the configuration of each of these services is made up of a plurality of objects and associated instances of those objects. An object can be any entity in an SDDC, such as a data center, a host cluster, a host, a datastore, a VM, and the like. An SDDC can include many instances of such objects (e.g., multiple clusters, each having multiple hosts, each executing multiple VMs, etc.). Objects can have properties and associated values. For example, a host object can have properties such as whether secure shell (SSH) is enabled or disabled; (2) host name; (3) NTP server name; and (4) keyboard layout, among other properties. Objects, instances, and object properties can be specified in the desired state document as the desired state of the SDDC.

VI profile service 201 exposes various APIs that are invoked by configuration agent 140 and the managed services. The APIs include a get-current-state API 211 that is invoked by configuration agent 140 to get the current state of SDDC 41, an apply API 212 that is invoked by configuration agent 140 to apply the desired state of SDDC 41 that is defined in a desired state document to SDDC 41, scan API 213 that is invoked by configuration agent 140 to compute drift in the current state of SDDC 41 from the desired state of SDDC 41, a streaming API 215 that provides an interface for configuration agent 140 by which configuration agent 140 receives streaming updates (including any drift detected in the current state of SDDC 41 from the desired state of SDDC 41) from VI profile service 201, and a notification API 216 that is invoked by any of the managed services to notify VI profile service 201 of a change in the configuration thereof. In the embodiments described herein, each of the managed services maintains the state of its configuration, detects any change to its configuration, and notifies VI profile service 201 through notification API 216 upon detecting any change in its configuration. Each of the managed services employs a notification technique, such as long-poll, HTTP SSE (Server Sent Events), HTTP2 streaming, and webhooks, to notify VI profile service 201 through notification API 216 upon detecting any change in its configuration. In addition, instead of a streaming API 215, VI profile service 201 may implement long-poll, HTTP SSE, HTTP2 streaming, or webhooks to notify configuration agent 140 of the updates including any drift detected in the current state of SDDC 41 from the desired state of SDDC 41.

VI profile service 201 includes a plug-in orchestrator 230 that refers to a plug-in registry 231 that contains information about each of the plug-ins including: (1) process IDs of the plug-in and the corresponding service; (2) whether or not the corresponding service is enabled for proactive drift detection, passive drift detection, or both; and (3) parameters for proactive drift detection and/or passive drift detection.

Parameters for proactive drift detection specify whether or not a queue is to be set up for each of the managed services that are enabled for proactive drift detection. These queues are depicted in FIG. 2 as queues 235 and are used to throttle incoming notifications from the managed services. As will be described below, for a managed service for which no queue is set up, VI profile service 201 will compute drift in the configuration of the managed service immediately upon receiving the notification of change from the managed service. For a managed service for which a queue is set up, parameters for proactive drift detection include a throttling interval, i.e., the time interval between drift computations.

Parameters for passive drift detection include a polling interval (or alternatively, minimum gap between polling) for each of the managed services that are enabled for passive drift detection. For passive drift detection, plug-in orchestrator 230 relies on drift poller 232 to provide a periodic trigger for drift computation. Drift poller 232 maintains a separate polling interval (or alternatively, minimum gap between polling) for each of the managed services that are enabled for passive drift detection.

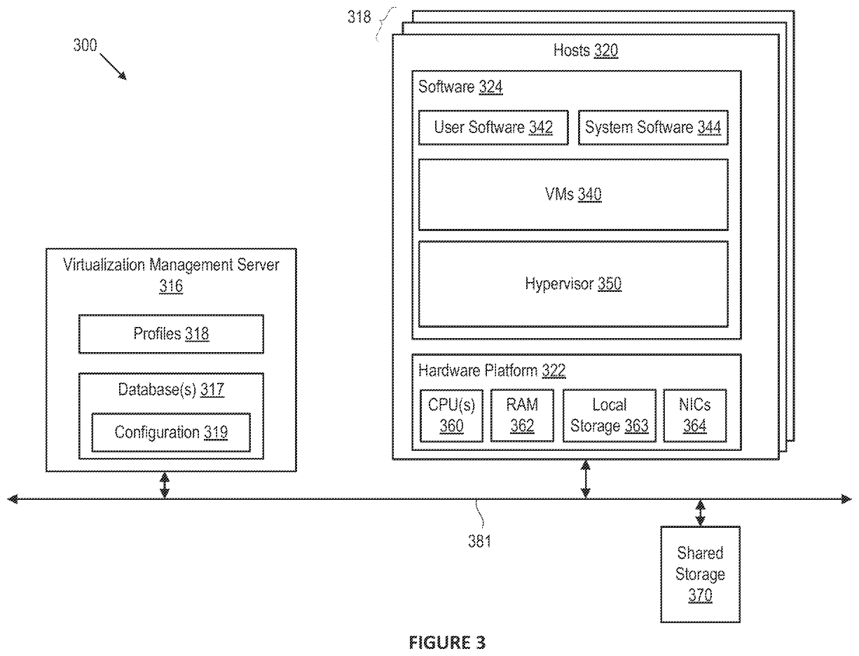

FIG. 3 is a block diagram of a virtualized computing system 300 in which embodiments described herein may be implemented. Virtualized computing system 300 includes hosts 320. Hosts 320 may be constructed on hardware platforms such as an x86 architecture platforms. One or more groups of hosts 320 can be managed as clusters 318. As shown, a hardware platform 322 of each host 320 includes conventional components of a computing device, such as one or more central processing units (CPUs) 360, system memory (e.g., random access memory (RAM) 362), a plurality of network interface controllers (NICs) 364, and optionally local storage 363. CPUs 360 are configured to execute instructions, for example, executable instructions that perform one or more operations described herein, which may be stored in RAM 362. NICs 364 enable host 320 to communicate with other devices through a physical network 381. Physical network 381 enables communication between hosts 320 and between other components and hosts 320 (other components discussed further herein). Physical network 381 can include a plurality of physical switches, physical routers, and like type network devices.

In the embodiment illustrated in FIG. 1, hosts 320 access shared storage 370 by using NICs 364 to connect to network 381. In another embodiment, each host 320 contains a host bus adapter (HBA) through which input/output operations (IOs) are sent to shared storage 370 over a separate network (e.g., a fibre channel (FC) network). Shared storage 370 include one or more storage arrays, such as a storage area network (SAN), network attached storage (NAS), or the like. Shared storage 370 may comprise magnetic disks, solid-state disks, flash memory, and the like as well as combinations thereof. In some embodiments, hosts 320 include local storage 363 (e.g., hard disk drives, solid-state drives, etc.). Local storage 363 in each host 320 can be aggregated and provisioned as part of a virtual SAN, which is another form of shared storage 370.

Software 324 of each host 320 provides a virtualization layer, referred to herein as a hypervisor 350, which directly executes on hardware platform 322. In an embodiment, there is no intervening software, such as a host operating system (OS), between hypervisor 350 and hardware platform 322. Thus, hypervisor 350 is a Type-1 hypervisor (also known as a “bare-metal” hypervisor). As a result, the virtualization layer in host cluster 318 (collectively hypervisors 350) is a bare-metal virtualization layer executing directly on host hardware platforms. Hypervisor 350 abstracts processor, memory, storage, and network resources of hardware platform 322 to provide a virtual machine execution space within which multiple virtual machines (VM) 340 may be concurrently instantiated and executed. VMs 340 can execute software deployed by users (e.g., user software 342), as well as system software 344 deployed by management/control planes to provide support (e.g., virtualization management server 316).

Virtualization management server 316 is a physical or virtual server that manages hosts 320 and the hypervisors therein (e.g., a VIM appliance). Virtualization management server 316 installs agent(s) in hypervisor 350 to add a host 320 as a managed entity. Virtualization management server 316 can logically group hosts 320 into host cluster 318 to provide cluster-level functions to hosts 320, such as VM migration between hosts 320 (e.g., for load balancing), distributed power management, dynamic VM placement according to affinity and anti-affinity rules, and high-availability. The number of hosts 320 in host cluster 318 may be one or many. Virtualization management server 316 can manage more than one host cluster 318. While only one virtualization management server 316 is shown, virtualized computing system 300 can include multiple virtualization management servers each managing one or more host clusters. Virtualization management service 316 includes database(s) 317 that store a configuration 319. Virtualization management server 316 can include profiles 318 managed by VI profile service 201, as discussed further below.

A selective configuration a user wants to manage through VI profile service 201 is referred to herein as a managed configuration. The portion of the configuration other than the selective configuration (i.e., the portion of the configuration the user does not want to manage through VI profile service 201) is referred to as the unmanaged configuration. Configuration 319 is the union of a managed configuration and the unmanaged configuration (also referred to as the comprehensive configuration).

One technique for generating a profile 318 is as follows. The profile includes a managed configuration. Any changes in the unmanaged configuration will not result in a drift of profile 318 from its desired state (profile drift), which is the expected behavior. The managed configuration can be any possible object or property supported by virtualization management server 316. However, the objects/properties in the unmanaged configuration may have dependencies on objects/properties in the managed configuration of the profile. Thus, VI profile service 201 does not guarantee the correctness of the profile when a user applies the profile. Thus, this technique does not deliver system resilience.

Another technique for generating a profile 318 is as follows. The profile includes the comprehensive configuration. When the profile is created, the user selects a managed configuration and the objects/properties of the unmanaged configuration are populated in the profile from the current running state. The system guarantees the profile correctness and the comprehensive configuration is always entirely passed to the plugins to validate/apply the managed configuration. Any changes in the unmanaged configuration will result in a configuration drift, since the profile includes the state of the unmanaged configuration at the time of creation. Race conditions between existing imperative APIs and VI profile service 201 may result in the unmanaged configuration being unintentionally overwritten by VI profile service 201 when applying the profile. This can result in an incorrect configuration.

Another technique for generating a profile 318 is as follows. The profile includes the comprehensive configuration. The user does not want to distinguish between the managed configuration and the unmanaged configuration. The user manages the entire configuration (configuration 319) through either VI profile service 201 or using existing imperative APIs provided by virtualization management service 316 (external to VI profile service 201). The downside of this approach is that a user cannot chose a subset of the configuration to manage in the profile through VI profile service 201 but must instead always be confronted with managing the entire configuration. Each user will see the same configuration despite being concerned with only a subset thereof.

In embodiments, a technique for generating a profile 318 is as follows. The profile includes only the managed configuration. The managed configuration includes only independent objects/properties. In other words, none of the objects/properties in the unmanaged configuration have dependencies on the objects/properties in the managed configuration. VI profile service 201 guarantees profile correctness. A drawback of this approach is that each plugin must expect partial input in some cases (e.g., some objects/properties used as parametric input to the plugin may be in the unmanaged configuration and not present in the profile). However, the plugin interface can be configured to expect that a user may omit optional arguments (e.g., the missing objects/properties in the unmanaged configuration can be treated as optional arguments for the plugin).

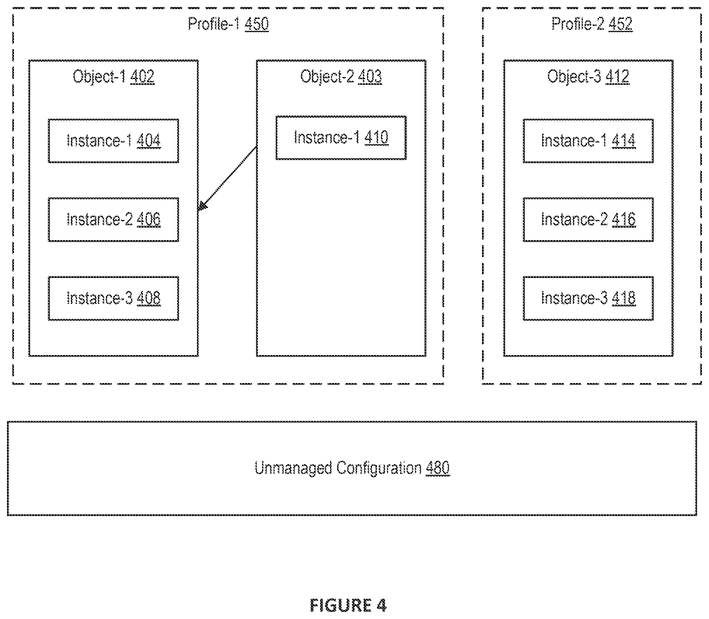

FIG. 4 is a block diagram depicting profiles managed by VI profile service 201 according to embodiments. As shown in FIG. 4, a profile 450 (profile-1) includes an object 402 (object-1) and an object 403 (object-2). Object 402 includes instances 404 (instance-1), 406 (instance-2), and 408 (instance-3). Object 403 includes an instance 410 (instance-1). Object 403 includes a dependency on object 402. There are no dependencies between profile 405 and the unmanaged configuration. A profile 452 includes an object 412 (object-3) having instances 414 (instance-1), 416 (instance-2), and 418 (instance-3). There are no dependencies between profile 452 and profile 450. There are no dependencies between profile 452 and the unmanaged configuration. Different users can create and manage profiles 450 and 452. For example, a first user can be in charge of profile-1 and applies profile-1 through VC profile service 201 on one or more VIM appliances. A second user can be in charge of profile 2 and applies profile 2 through VC profile service 201 on one or more VIM appliances. In another example, a user can create multiple profiles and manage the comprehensive configuration through the multiple profiles. For example, a user can create two profiles-the first profile specifies common configuration across multiple VIM appliances and the second profile specifies unique configuration for a specific VIM appliance. The intersection between profiles is an empty set. That is, VC profile service 201 does not allow the same object to be managed through two different profiles.

Consider a case where an object (object-4) in unmanaged configuration 480 depends on an object (object-1) in profile-1. VC profile service 201 indicates such a profile as invalid because the profile must include the objects that depend any other object in the profile. The reason for this is that an instance in object-2 (instance-1) may depend on an instance in object-1 that is not defined in the profile (e.g., instance-4). In such case, instance-4 in object-1 will get removed when profile-1 is applied, but VC profile service 201 may not notify the user since, from its point of view, the system is in a consistent state.

Consider a case where an object in profile-2 depends on an object in unmanaged configuration 480 (an object-4). VC profile service 201 indicates such a profile as invalid because the profile must include the objects that depend any other object in the profile. The reason for this is that if the user removes object-3: instance-1, then that could make invalid some instance(s) in object-4. However, VC profile service 201 may not notify the user because, from its viewpoint, the system is in a consistent state.

Consider a case where instances of an object are split between two profiles. VC profile service 201 indicates such profiles as invalid because a profile cannot partially manage an object. The reason is because when such a profile is applied, the system does not know how to treat the rest of the instances (leave them or remove them) since those instances are not part of the profile.

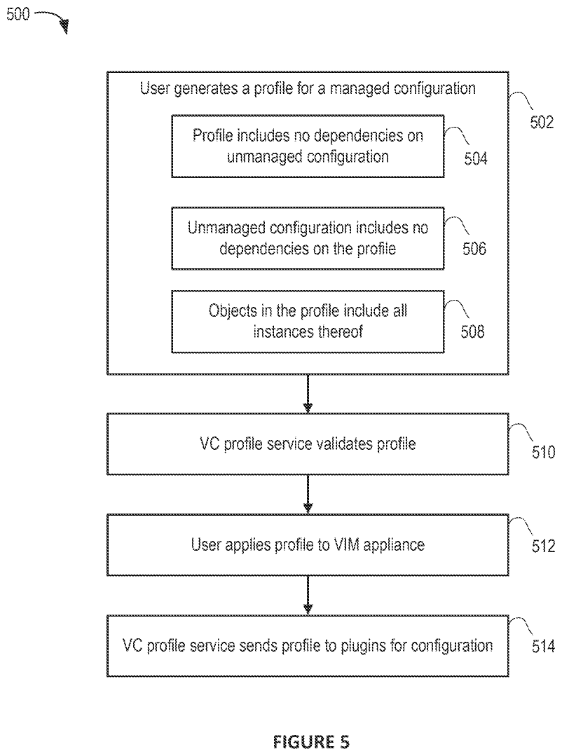

FIG. 5 is a flow diagram depicting a method 500 of generating and applying a profile to a virtualization management service in an SDDC according to embodiments. Method 500 begins at step 502, where a user generates a profile for a managed configuration. The managed configuration includes less than configuration 319 (e.g., a subset of the configuration the user wants to manage through the profile). The profile includes no dependencies on the unmanaged configuration (step 504). The unmanaged configuration includes no dependencies on the profile (step 506). Objects in the profile includes all instances thereof (step 508). That is, instances of an object are not split between profiles or between the profile and the unmanaged configuration.

At step 510, VC profile service 201 validates the profile. VC profile service 201 ensures the profile is correct based on the rules described for steps 504-508. At step 512, the user applies the profile to a VIM appliance. At step 514, VC profile service 201 in the VIM appliance sends the profile to its plugins for configuration thereof.

The embodiments described herein may employ various computer-implemented operations involving data stored in computer systems. For example, these operations may require physical manipulation of physical quantities. Usually, though not necessarily, these quantities may take the form of electrical or magnetic signals, where the quantities or representations of the quantities can be stored, transferred, combined, compared, or otherwise manipulated. Such manipulations are often referred to in terms such as producing, identifying, determining, or comparing. Any operations described herein that form part of one or more embodiments may be useful machine operations.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing a configuration of a virtualization management server in a software-defined data center (SDDC), the virtualization management server managing a cluster of hosts and a virtualization layer executing therein, the method comprising:
generating, by a service executing in the SDDC, a profile that includes a managed configuration exclusive of an unmanaged configuration, a union of the managed configuration and the unmanaged configuration being a configuration of the virtualization management server;
validating, by the service, that the unmanaged configuration in the profile does not include dependencies with the unmanaged configuration;
applying, by the service, the profile to the virtualization management server.

2. The method of claim 1, wherein the service validates that the profile includes no dependencies on the unmanaged configuration.

3. The method of claim 1, wherein the service validates that the unmanaged configuration includes no dependencies on the profile.

4. The method of claim 1, wherein the service validates that the managed configuration in the profile includes all instances of an object therein and that there are no instances of the object in the unmanaged configuration.

5. The method of claim 1, wherein the step of applying comprises:
sending, by the service, the profile to a plurality of plug-ins executing in the virtualization management server;
updating, by the plurality of plug-ins, the configuration of the virtualization management server in response to the profile.

6. The method of claim 5, wherein a first plug-in of the plurality of plug-ins has an interface that expects a portion of the managed configuration in the profile and a portion of the unmanaged configuration, and wherein the interface indicates the portion of the unmanaged configuration as optional.

7. The method of claim 1, wherein the managed configuration includes an object, and wherein the service validates that the profile includes all instances of the object.

8. A non-transitory computer readable medium comprising instructions that are executable on a processor of a computer system to carry out a method of managing a configuration of a virtualization management server in a software-defined data center (SDDC), the virtualization management server managing a cluster of hosts and a virtualization layer executing therein, the method comprising:
generating, by a service executing in the SDDC, a profile that includes a managed configuration exclusive of an unmanaged configuration, a union of the managed configuration and the unmanaged configuration being a configuration of the virtualization management server;
validating, by the service, that the unmanaged configuration in the profile does not include dependencies with the unmanaged configuration;
applying, by the service, the profile to the virtualization management server.

9. The non-transitory computer readable medium of claim 8, wherein the service validates that the profile includes no dependencies on the unmanaged configuration.

10. The non-transitory computer readable medium of claim 8, wherein the service validates that the unmanaged configuration includes no dependencies on the profile.

11. The non-transitory computer readable medium of claim 8, wherein the service validates that the managed configuration in the profile includes all instances of an object therein and that there are no instances of the object in the unmanaged configuration.

12. The non-transitory computer readable medium of claim 8, wherein the step of applying comprises:
sending, by the service, the profile to a plurality of plug-ins executing in the virtualization management server;
updating, by the plurality of plug-ins, the configuration of the virtualization management server in response to the profile.

13. The non-transitory computer readable medium of claim 12, wherein a first plug-in of the plurality of plug-ins has an interface that expects a portion of the managed configuration in the profile and a portion of the unmanaged configuration, and wherein the interface indicates the portion of the unmanaged configuration as optional.

14. The non-transitory computer readable medium of claim 8, wherein the managed configuration includes an object, and wherein the service validates that the profile includes all instances of the object.

15. A computer system, comprising:
a software-defined data center (SDDC) having a virtualization management server managing a cluster of hosts and a virtualization layer executing therein;
a service, executing on a host of the SDDC, configured to:
generate a profile that includes a managed configuration exclusive of an unmanaged configuration, a union of the managed configuration and the unmanaged configuration being a configuration of the virtualization management server;
validate that the unmanaged configuration in the profile does not include dependencies with the unmanaged configuration;
apply the profile to the virtualization management server.

16. The computer system of claim 15, wherein the service validates that the profile includes no dependencies on the unmanaged configuration.

17. The computer system of claim 15, wherein the service validates that the unmanaged configuration includes no dependencies on the profile.

18. The computer system of claim 15, wherein the service validates that the managed configuration in the profile includes all instances of an object therein and that there are no instances of the object in the unmanaged configuration.

19. The computer system of claim 15, wherein the service applies the profile by:
sending the profile to a plurality of plug-ins executing in the virtualization management server; and
updating, by the plurality of plug-ins, the configuration of the virtualization management server in response to the profile.

20. The computer system of claim 19, wherein a first plug-in of the plurality of plug-ins has an interface that expects a portion of the managed configuration in the profile and a portion of the unmanaged configuration, and wherein the interface indicates the portion of the unmanaged configuration as optional.
